(19) United States
(12) Patent Application Publication
(10) Pub. No.: US 2004/0044578 A1
(43) Pub. Date: Mar. 4, 2004

(54) Online networking system for efficient operation of restaurants and method therefor

(76) Inventors: David Soo Do Kim, Birmingham, AL (US); Hyung Chang Bae, Cerritos, CA (US)

Correspondence Address: PARK & SUTTON LLP, 3255 WILSHIRE BLVD, SUITE 1110, LOS ANGELES, CA, 90010, US

(21) Appl. No.: 10/230,477

(22) Filed: Aug. 29, 2002

(51) Int. Cl. G06F 17/60

(52) U.S. Cl. 705/15

(57) ABSTRACT

Provided are an online networking system for an efficient operation of restaurants and a method therefore, in which restaurant customers and food material providers input order sheets and estimations of food material prices into a website and restaurants receive the order sheets and the estimations via facsimile so that restaurants serve more customers in circumstances of limited equipment, staffs, place, and time, and purchase food materials from the food material providers presenting a lowest price. The online networking system includes a service provider for operating and managing a web server that provides the website, restaurant customers, food material providers, and the restaurant connected to the web server via Internet terminals and a facsimile. Here, the web server includes a certification server for processing pre-registrations by customers and food material providers themselves, changes, and certifications of members, a restaurant server for managing menu information on restaurants, an order server for processing orders, a food material estimation server for processing the estimation of the food material prices, a mail server, and a facsimile server. Therefore, the restaurant customers or food material providers are directly connected to the menu list screen or the web page of the registered restaurants respectively so that ordering food or submitting the estimation of food material prices is simplified. In addition, the restaurants receive estimations in which the prices of the food materials are compared by the one-to-one price list via the facsimile so that the restaurants can purchase food materials at a lower price.

### BACKGROUND OF THE INVENTION

1. Field of the Invention

The present invention relates to an online networking system for an efficient operation of restaurants and a method therefor, and more particularly, to an online networking system for an efficient operation of restaurants and a method therefor in which customers order and pick up lunch from restaurants that have been registered as favorite restaurants on a website in the Internet, and food material providers present an estimation of food materials on the website for the restaurants to order food materials based on the estimation.

2. Description of the Related Art

A plurality of methods for online business related to restaurants have been introduced; however, these methods cannot solve the following problems.

First, there are problems about ordering food. Most restaurants have a serious problem in how to serve as many customers as possible during lunchtime in the circumstances of limited equipment and staffs; in particular, the problem is more serious for restaurants located downtown and office districts where most sales occur during lunchtime. If a waiting line is long due to delays in handling orders, customers grow impatient and restaurants cannot expect the increasing of sales. In addition, after the staffs have prepared for lunchtime, dead times occur for waiting lunchtime customers.

Generally, most lunch customers buy lunch from two or three favorite restaurants that are located within a walking distance, and such customers are inclined to choose the same favorite menu generally. Accordingly, although the orders of the regular customers can be handled in a short time, the regular customers also have to wait in line for a long time in order to pick up their orders.

To prevent such inconveniences, customers order food from restaurants via telephone or facsimile and pick up the food after a predetermined time.

However, when the restaurants are very busy, it is difficult to respond to the orders via telephone and even experienced counters could miss options by mistake so that food may be prepared incorrectly.

Moreover, in the case where customers order food via facsimile, the customers have inconveniences of writing the contents of orders and sending the written orders via facsimile. If customers are unfamiliar with the menus of restaurants, such a method cannot be practiced. In addition, if the restaurant lacks the materials for the food ordered via facsimile, the effort of ordering food via facsimile is in vain.

In the other method for ordering food, restaurants build websites and take orders via e-mail. However, building and operating a website are equipment and cost consuming and a person in charge for managing the website must be hired. As a consequence, most restaurants are not confident with the effects of websites, thereby not building an online ordering system via the Internet.

Second, there are problems about purchasing food materials. After lunchtime, restaurants have to check for exhausted food materials and order food materials that will be used the next day. In this case, it is difficult for restaurants to have exact price information on various food materials. In addition, comparing the prices of food materials suggested by a plurality of food material providers is time and labor consuming.

In order to compare the prices of food materials and order the food materials before a delivery order closure time, i.e., generally around 4 o'clock in the afternoon, a person in charge has no enough time to check the food materials left or needed after a busy lunchtime and call a plurality of food material providers or salespeople to compare the prices of the food materials one by one. Since a plurality of people in charge of purchasing food materials may try to call salespeople around the delivery order closure time, it is difficult to contact the salespeople who are mostly driving a car and to talk to them for a long time even when the connection is successful.

In addition, even if the food material providers provide the price estimation of food materials via facsimile, it is difficult to compare the prices of every material one by one and decide on the purchasing because the food material packing units and the listed order of the materials are different each other according to food material providers.

Therefore, the person in charge of purchasing food materials does not compare in detail the prices of the food materials, but finally order the food materials only for preventing interruptions in being provided with food materials the next early morning. Accordingly, a chance for saving costs by purchasing food materials at the lowest prices is lost.

### SUMMARY OF THE INVENTION

To solve the above-described problems about ordering food, it is an objective of the present invention to provide an online networking system for an efficient operation of restaurants and a method therefor. Accordingly, customers visit the website of an online networking system service provider in order to register by themselves their favorite restaurants by inputting telephone numbers of the restaurants, which are members of the online networking system service, so that the customers are directly connected to one menu list screen of all favorite restaurants pre-reregistered by themselves whenever visiting the website to order food. In addition, restaurants also receive orders to prepare food via facsimile or wireless devices and the customers pick up the ordered food at the restaurants.

To solve the above-described problems about purchasing food materials, it is another objective of the present invention to provide an online networking system for an efficient operation of restaurants and a method therefor. Accordingly, food material providers visit the website of an online networking system service provider in order to register by themselves their food material delivery restaurants by inputting telephone numbers of the restaurants, which are members of the online networking system service. When the food material providers present price estimation of food materials on the one-to-one price list which is pre-formatted in one unified table, the estimated prices are converted into the one-to-one prices sorted in order and compared with one another and an estimation representing the comparison results is supplied to the restaurants via facsimile, so that the restaurants can purchase food material at lower prices.

### BRIEF DESCRIPTION OF THE DRAWINGS

The above objectives and advantages of the present invention will become more apparent by describing in detail preferred embodiments thereof with reference to the attached drawings in which:

FIG. 1 is a view illustrating a configuration of an online networking system for an efficient operation of restaurants according to the present invention;

FIG. 2 is a flowchart illustrating processes for customers and food material providers to register at a website and input basic information in an online networking method for an efficient operation of restaurants according to the present invention;

FIGS. 3 and 4 are flowcharts illustrating processes for ordering food in an online networking method for an efficient operation of restaurants according to the present invention; and

FIGS. 5 and 6 are flowcharts illustrating processes for estimating prices of food materials in an online networking method for an efficient operation of restaurants according to the present invention.

### DETAILED DESCRIPTION OF THE INVENTION

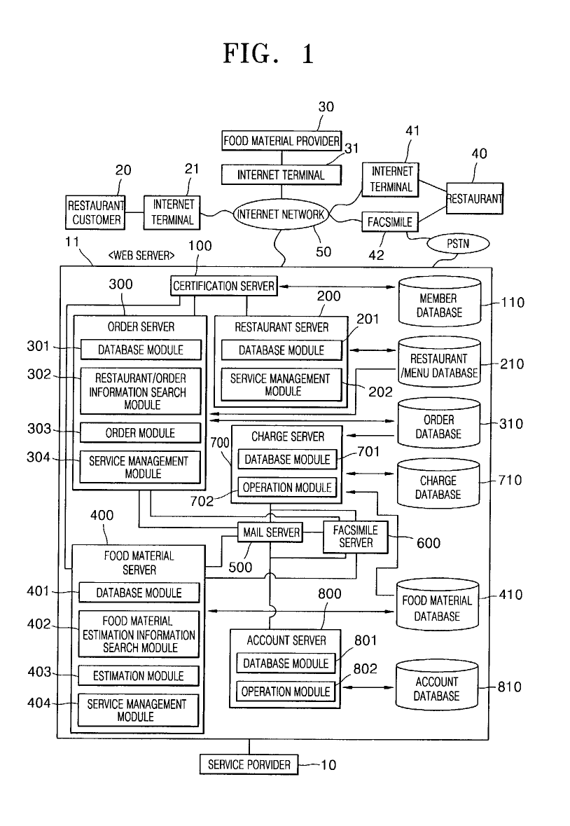

FIG. 1 is a view illustrating the configuration of an online networking system for an efficient operation of restaurants according to the present invention. An online networking system according to the present invention includes a service provider 10 of a website for providing an online networking service, a web server 11 for operating and managing a website, a restaurant customer 20, a food material provider 30, and a restaurant 40.

The restaurant customer 20, the food material provider 30, and the restaurant 40 are connected to the web server 11 through Internet terminals 21, 31, and 41 or through a facsimile 42 connected to the Internet network 50, respectively. Here, the restaurant 40 is connected to the web server 11 through the facsimile 42 connected to the public switched telephone networks (PSTN) as well as through the Internet terminal 41, such as a computer or a PDA, and the Internet network 50. Therefore, the restaurant 40 receives information via e-mail or facsimile from the web server 11.

The web server 11 includes a certification server 100 for processing registrations, changes, and certifications of members, a restaurant server 200 for managing general information on restaurants, such as names and telephone numbers and menu information, an order server 300 for providing information on the restaurants for restaurant customers which intend to order food, a food material estimation server 400 for receiving estimations of food material delivery prices from food material providers, a mail server 500 for receiving order of food and/or estimations of food material delivery prices, a facsimile server 600 for converting the order of food and/or food material delivery estimation prices into a facsimile document format to be sent through a facsimile of the restaurant, a charge server 700 for calculating rates according to the handling results of the order of food and the food material delivery prices, and an account server 800 for creating financial statements based on the purchases and sales data of the restaurant.

More specifically, the certification server 100 interacts with a member database 110 to process registrations, changes, and certifications of the restaurant customers 20, the food material providers 30, and the restaurants 40. In addition, whenever the restaurant customers 20 and the food material providers 30 sign in the website after having registered favorite restaurants and food material delivery restaurants, respectively, by inputting the telephone numbers of the restaurants 40, the certification server 100 connects the restaurant customers 20 and the food material providers 30 to the web pages of the registered restaurants 40 and allows them to use the services of the website.

The restaurant server 200 is formed of a database module 201 interacting with a restaurant/menu database 210 to store information on the member restaurants, such as name, address, telephone number, and menu, in the restaurant/menu database 210, and a service management module 202 for supplying the result of processing the restaurant information.

The order server 300 is formed of a database module 301, a restaurant information/order information search module 302, an order module 303 for receiving the processing orders from the restaurant customers 20, and a service management module 304 for supplying the results of processing the orders. Here, the database module 301 interacts with the restaurant/menu database 210 and an order database 310 to read the information on the restaurants, such as name, address, telephone number, and menu, from the restaurant/menu database 210 and display the information so as to store the order result in the order database 310. The restaurant information/order information search module 302 respectively reads the information on the member restaurants selected by the restaurant customer 20 and the order history of the restaurant customer 20 from the restaurant/menu database 210 and the order database 310 as default to display the information on a screen or allow the restaurant customers 20 to search information.

The food material server 400 includes a database module 401, a food material estimation information search module 402 for searching estimation information from the food material database 410, an estimation module 403 for receiving the prices of the food materials suggested by the food material providers 30, and a service management module 404 for supplying the results of processing the prices of the food materials. Here, the database module 401 interacts with a food material database 410 including items of food materials required in restaurants, a form for presenting the estimation, and delivery prices of the food materials to manage the food material database.

The mail server 500 receives e-mails about the order of food and the estimation of the food material delivery prices from the restaurant customers 20 and the food material providers 30, respectively, and sends the e-mails about the order of food and the estimation of the food material delivery prices processed in the mail server 500 to the restaurants 40.

The facsimile server 600 converts the order of food and the estimation of the food material delivery prices processed in the order server 300 and the food material server 400, respectively, into facsimile document formats and sends them to the restaurant 40 via facsimile 42.

The charge server 700 includes a database module 701 for reading an order history data for a specific period from the order database 310 and an operation module 702 for calculating rates of the member restaurants according to the results of processing the food orders. Here, bills created in the operation module 702 are transferred to the member restaurants 40 via the mail server 500 or the facsimile server 600.

The account server 800 includes a database module 801 and an operation module 802. Here, the database module 801 interacts with an account database 810 to manage account information, such as purchase data and sales data, supplied from the restaurants 40. The operation module 802 creates various financial statements, such as balance statement and statement of profits and losses, based on the account database of the restaurants for a specific period, which is supplied from the database module 801. The financial statements supplied from the operation module 802 are transferred to the restaurants 40 by the mail server 500 or the facsimile server 600.

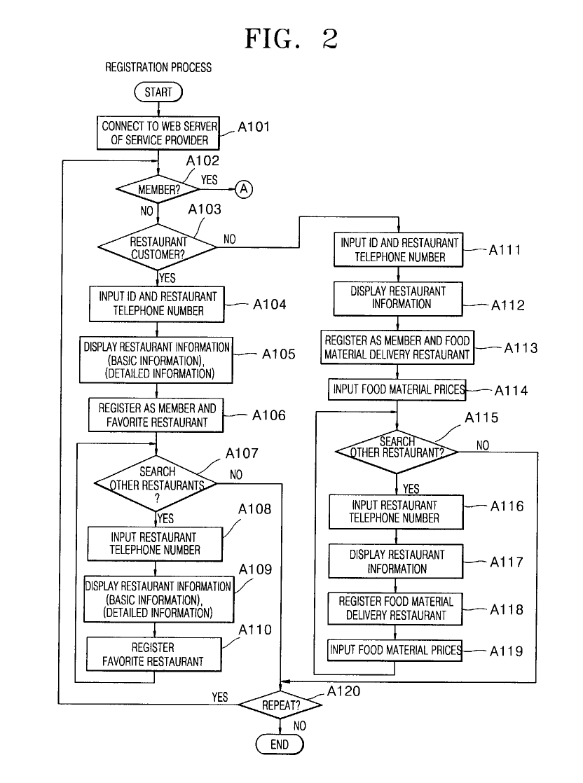

Processes of an online networking method for an efficient operation of restaurants according to the present invention will now be described with reference to the flowcharts of FIGS. 2 through 6.

FIG. 2 is a flowchart illustrating processes for restaurant customers and food material providers to register at a website and input basic information in an online networking method for an efficient operation of restaurants according to the present invention.

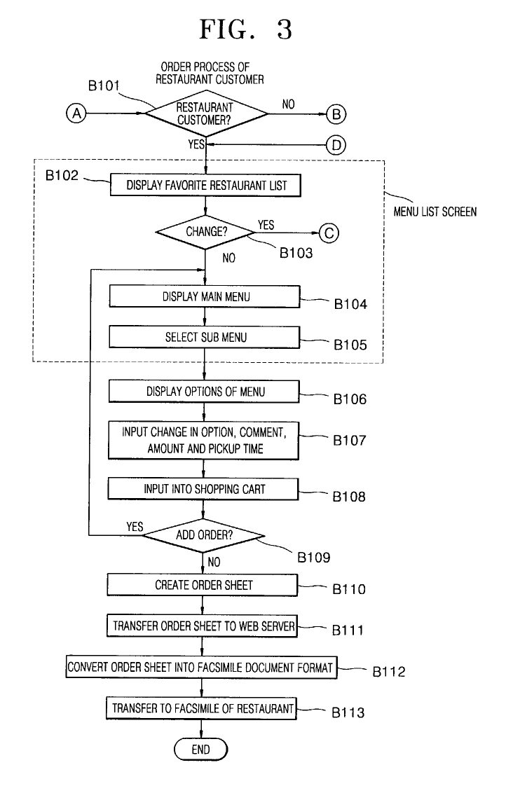

A restaurant customer 20 and a food material provider 30 connect to a web server 11 through the Internet network 50 in step A101. If the restaurant customer 20 and the food material provider 30 are members of the website, a signing in process of FIG. 3 is performed. If the restaurant customer 20 and the food material provider 30 are not members of the website, a process for registering as members of the website and inputting basic information are performed in step A102.

In the case of the restaurant customer 20 in step A103, the restaurant customer 20 inputs an e-mail address as an identification (ID), a password, and the telephone number of a restaurant to be registered as a favorite restaurant in step A104. Thereafter, the customer 20 inputs its office name, telephone number, and address thereof in a detailed information input window. Meanwhile, information on the restaurant 40 having the same telephone number as that input by the restaurant customer 20 is loaded from a restaurant/menu database 210 and displayed with the detailed information input window in step A105. The restaurant customer 20 inputs detailed information and checks the information on the restaurant to register the restaurant as a favorite restaurant in step A106. In order to additionally register other restaurants as favorite restaurants in step A107, the restaurant customer 20 inputs the telephone numbers of the restaurants in step A108. Thereafter, when the information on the restaurants is displayed on a screen in step A109, the restaurant customer 20 confirms the restaurants to register as favorite restaurants in step A110.

If a restaurant having the same telephone number as that input by the restaurant customer 20 is absent in the restaurant/menu database 210, a list of restaurants having the same local number as the local number of the telephone number input by the restaurant customer 20 is displayed in a separate window from the detailed information input window. Accordingly, the restaurant customer 20 may select a restaurant from the list and register the restaurant as a favorite restaurant. Here, it is possible to search a restaurant by using the local number of the telephone number of the customer 20 or the name of a restaurant as a keyword.

In the case of the food material provider 30 in step A103, the food material provider 30 inputs an e-mail address as an ID, a password, and the telephone number of a restaurant to be registered as a food material delivery restaurant in step A111. Thereafter, the food material provider 30 inputs information on the food material provider 30 and a salesperson in charge of the restaurant in a detailed information input window. Meanwhile, information on the restaurant 40 having the same telephone number as that input by the food material provider 30 is loaded from a food material database 410 and displayed with the detailed information input window in step A112. The food material provider 30 inputs detailed information and checks the information on the restaurant to register the restaurant as a food material delivery restaurant in step A113, and creates an estimation table about food material prices for the restaurant in step A114. In order to additionally register other restaurants as food material delivery restaurants and create an estimation table in step A115, the food material provider 30 inputs the telephone numbers of the restaurants in step A116. Thereafter, when the information on the restaurants is displayed on a screen in step A117, the food material provider 30 confirms the restaurants to register as the food material delivery restaurants in step A118 and creates the estimation table about food material prices in step A119.

If a restaurant having the same telephone number as that input by the food material provider 30 is absent in the food material database 210, a list of restaurants having the same local number as the local number of the telephone number input by the food material provider 30 is displayed in a separate window from the detailed information input window. Accordingly, the food material provider 30 may select a restaurant from the list and register the restaurant as a food material delivery restaurant. Here, it is possible to search a restaurant by using the local number of the telephone number of the food material provider 30 or the name of a restaurant as a keyword.

Although it is possible that restaurants register with in the website as members and upload the information on the restaurants to the website through the Internet, this is a difficult task for most restaurants. Therefore, it is preferable that a service provider 10 of a web server receives the information on the restaurants via telephone or facsimile, and registers and uploads the general information and menu information on the restaurants.

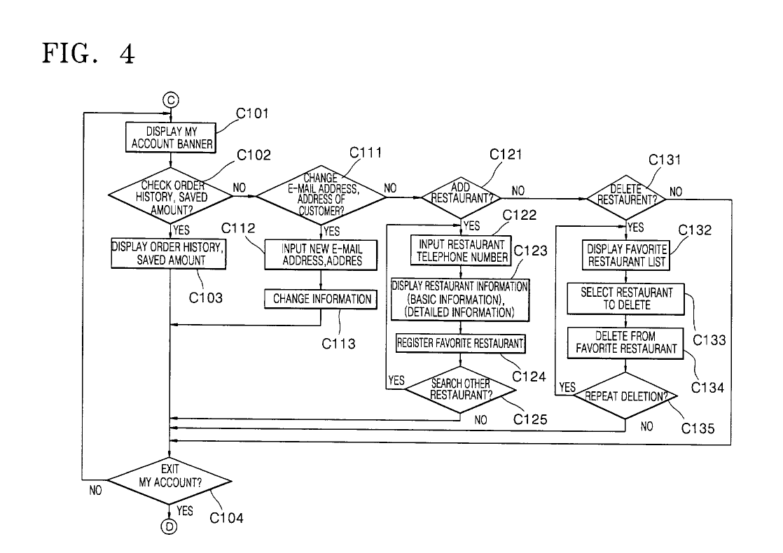

FIGS. 3 and 4 are flowcharts illustrating processes for ordering food in an online networking method for an efficient operation of restaurants according to the present invention.

When a registered restaurant customer 20 signs in a website in step B101, the list of favorite restaurants and a main menu list and a sub menu list of the restaurants are displayed on one screen in steps B102 through B105. Here, the screen is divided into a plurality of windows on which the name, main menu list, and sub menu list of each restaurant are displayed. The main menu list presents the names of most popular dishes as lunch and brief descriptions thereof, and the sub menu list presents the names of other dishes and brief descriptions thereof.

In order to change the list of the general restaurants in step B103, the restaurant customer 20 clicks on a my account banner to move to a my account web page. The restaurant customer 20 can delete and add favorite restaurants in the my account web page as shown in FIG. 4. In the my account web page, an order history, discounted amount, and saved amount of the restaurant customer 20 may be checked in steps C102 and C103, and the address and e-mail address of the restaurant customer 20 can be changed in steps C111 through C113. In addition, the restaurant customer 20 may add restaurants to the favorite restaurant list in steps C121 through C125 and delete restaurants from the favorite restaurant list in steps C131 through C135.

When the favorite restaurant list does not require changing, the restaurant customer 20 chooses a dish from the menu windows of the favorite restaurants in step B105. In this case, the previously ordered options about the chosen dish are displayed on the screen in step B106. The restaurant customer 20 changes the options and number by clicking check boxes using a mouse and inputs comments and pickup time in step B107. Here, the pickup time is input when ordering food so that restaurants 40 can determine an order for preparing foods.

After inputting the order, the restaurant customer 20 puts the order in a shopping cart in step B108. When an additional order occurs in step B109, the process in steps B104 through B108 are repeated.

When the ordering food is completed, an order module 303 creates an order sheet in step B110. The order sheet is transferred to a mail server 500 in an e-mail type in step B111 and converted into a facsimile document format by a facsimile server 600 in step B112. Thereafter, the order sheet is transferred to and printed by a facsimile 42 in the restaurant 40 in step B113. The ordered information is stored in an order database 310 and used as a reference for the next order of the restaurant customer 20 so that the restaurant customer 20 can order food more conveniently.

As described above, whenever a restaurant customer who has registered favorite restaurants on a website connects to and signs in the website to order lunch, the menu lists of all favorite restaurants are instantly displayed on one screen so that the customer can simply complete ordering by clicking on desired dishes.

In addition, since dishes other than the dishes previously ordered are displayed on the menu list screen, a restaurant customer 20 can easily order any dish of the restaurant that has been registered as a favorite restaurant.

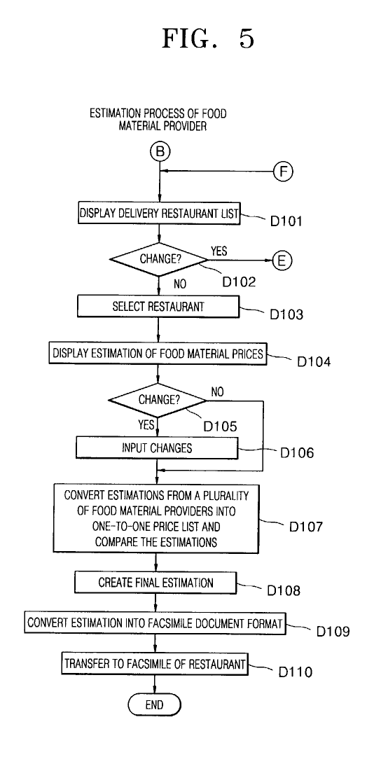

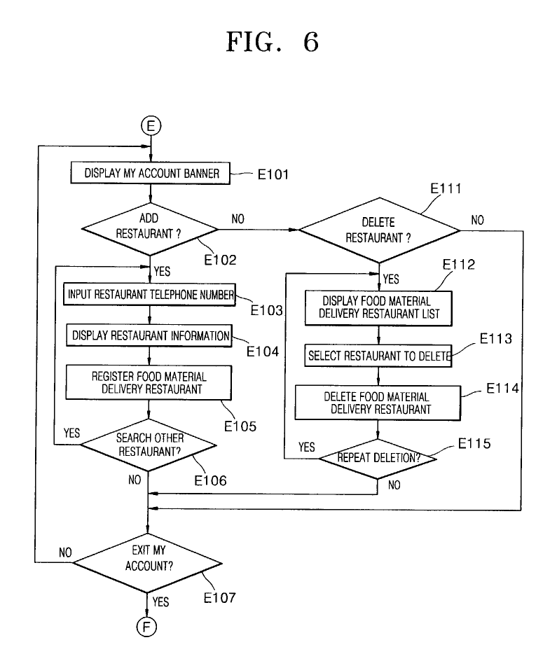

FIGS. 5 and 6 are flowcharts illustrating process for estimating the prices of food materials in an online networking method for an efficient operation of restaurants according to the present invention.

When a registered food material provider 30 signs in a website, a list of food material delivery restaurants is displayed on a screen in steps D101. In order to change the list of the food material delivery restaurants in step D102, the food material provider 30 clicks a my account banner to move to a my account web page. The food material provider 30 can delete and add the food material delivery restaurants in the my account web page as shown in FIG. 6. In order to add a food material delivery restaurant in the my account web page, the food material provider 30 searches a restaurant, register the restaurant as a food material delivery restaurant, and inputs an estimation of food material prices on the one-to-one price list in steps E102 through E105. In order to search other restaurants in step E106, the processes in steps E102 through E105 are repeated. In order to delete a food material delivery restaurant from the list of the food material delivery restaurants, the food material provider 30 selects the restaurant and deletes it. In order to delete other restaurants, the processes in steps E111 through E115 are repeated.

When the food material delivery restaurant list does not require changing, the food material provider 30 selects a restaurant from the food material delivery restaurant list in steps D101 through D103. In this case, the previous estimation of food material delivery prices for the selected restaurant is loaded from the food material database 410 and displayed on the screen so that the food material provider 30 inputs changes in the estimation in steps D104 through D106. When a plurality of food material providers completed inputting the estimations of the food material prices for one restaurant, an estimation module 403 converts the price estimations of the food material providers into the price estimations according to the one-to-one price list and compares the price estimations one by one in step D107 to create a final estimation in step D108.

Meanwhile, it is possible that the food material server 400 provides an estimation table using the one-to-one price list for each food material so that the food material providers input the delivery prices according to the provided one-to-one price list.

The final estimation created in the estimation module 403 is converted into a facsimile document format in a facsimile server 600 and transferred to a facsimile 42 of a restaurant 40. A person in charge of purchasing food material receives the final estimation in which the estimations from a plurality of food material providers 30 are compared according to the one-to-one price list. Accordingly, the person in charge of purchasing food material can order the food materials from the food material provider presenting the lowest price.

A customer who orders food by an online networking system for an efficient operation of restaurants and a method therefor can order food by clicking a mouse at least four times after connecting to a website due to having registered favorite restaurants in the website. In addition, the customer can easily order any kind of dish from the favorite restaurants that the customer has never ordered as well as dishes that the customer has previously ordered.

The customer orders food while watching the menu displayed in the menu list screen of the favorite restaurants so that the customer can order food correctly. In addition, the customer can order the same food with reference to the order history of the customer. Moreover, when the customer uses a wireless device, the customer can order food without using a computer so that a drive-through order is possible.

If a restaurant provides a discount service for the customers who ordered food before lunchtime, the customers can enjoy food at a lower price and the restaurant can increase sales due to increase of customers and efficient management of staffs.

Since registered customers can order food via e-mail and order sheets transferred via facsimile includes brief personal information on the customer, no-shows are remarkably reduced. Accordingly, loss in the sales by no-shows can be prevented.

A food material provider who presents an estimation of food material prices by an online networking system for an efficient operation of restaurants and a method therefor can input the estimation to a plurality of restaurants during non-rush hours, thereby promoting a larger number of restaurants. In addition, the food material provider can secure time for managing customer restaurants. Moreover, the food material providers can unaffectedly supply the estimations regardless of changes in their district salespeople or people in charge of purchasing food materials of the restaurants.

The restaurants can compare in detail the estimations of food material prices by a plurality of food material providers and order the food materials from the food material provider who presents the lowest price so that the restaurants can save money. In addition, the estimation of food material prices presents the prices of the food material with correct descriptions and options of the materials so that errors in ordering and delivering of the food materials are prevented even if the person in charge of purchasing food material or a salesperson of the food material provider is changed.

What is claimed is:

1. An online networking system for an efficient operation of restaurants, the online networking system comprising:
a service provider 10 for operating and managing a web server 11 that provides a website for an online networking service;
a plurality of restaurant customers 20 for connecting to the web server 11 via an Internet terminal 21 to order food;
a plurality of food material providers 30 for connecting to the web server 11 via an Internet terminal 31 to present an estimation of food material prices; and
a plurality of restaurants 40 for connecting to the web server 11 via an Internet terminal 41 or a facsimile machine 42 to receive an order sheet and/or an estimation of food material prices via e-mail or facsimile,
wherein, the web server 11 includes:
a certification server 100 for processing registration, change, and certification of members;
a restaurant server 200 for managing menu information of the restaurant 40;
an order server 300 for providing information on the restaurants 40 to the restaurant customer 20 to process orders;
a food material estimation server 400 for receiving estimations of food material prices from the food material providers 30;
a mail server 500 for transferring the order of food and/or the estimation of food material prices via e-mail to the restaurant 40; and
a facsimile server 600 for converting the order of food and/or the estimation of food material prices into a facsimile document format and transferring the format to the facsimile machine 42 of the restaurant 40.

2. The online networking system of claim 1, wherein the restaurant server 200 interacting with a restaurant/menu database 210 storing the names, addresses, telephone numbers, and menus of restaurants includes:
a database module 201 for managing data in the restaurant/menu database 210; and
a service management module 202 for supplying changes of the database.

3. The online networking system of claim 1, wherein the order server 300 interacting with the restaurant/menu database 210 storing the names, addresses, telephone numbers, and menus of restaurants and an order database 310 storing order history includes:
a database module 301 for managing the data of the restaurant/menu database 210 and the order database 310;
a restaurant information/order information search module 302 for searching the data in the restaurant/menu database 210 and the order database 310 according to restaurants, telephone numbers, order histories, and food types;
an order module 303 for receiving orders from the plurality of the restaurant customers 20; and
a service management module 304 for supplying the results of processing orders.

4. The online networking system of claim 1, wherein the food material server 400 interacting with a food material database 410 in which food materials purchased by restaurants are sorted according to restaurants, telephone numbers, contents of estimations, and items includes:
a database module 401 for managing the data of the food material database 410;
a food material estimation information search module 402 for searching the data of the food material database 410 according to restaurants, telephone numbers, contents of estimations, and items of food materials;
an estimation module 403 for receiving estimations of food material prices from the plurality of the food material providers 30 and converting the estimated prices into prices by the one-to-one price list to compare the estimated prices and create a final estimation; and
a service management module 404 for supplying the results of processing estimations.

5. The online networking system of claim 1, wherein the food material server 400 interacting with a food material database 410 in which food materials purchased by restaurants are sorted according to restaurants, telephone numbers, contents of estimations, and items includes:
a database module 401 for managing the data of the food material database 410;
a food material estimation information search module 402 for searching the data of the food material database 410 according to restaurants, telephone numbers, contents of estimations, and items of food materials;
an estimation module 403 for receiving estimations of food material prices according to the one-to-one price list from the food material providers 30 to compare the estimated prices by items and create a final estimation; and
a service management module 404 for supplying the results of processing estimations.

6. The online networking system of claim 3, further comprising a charge server 700 interacting with the order database 310 for calculating rates according to the orders to the restaurants 40 by applying a predetermined rating.

7. The online networking system of claim 1, further comprising an account server 800 for creating financial statements based on the purchases and sales data from the restaurants 40 and storing the purchases and sales data and the financial statements in an account database 810 in order to manage the financial statements and purchases and sales data.

8. An online networking method for an efficient operation of restaurants, the method comprising:
a first act wherein a website of an online networking service for an efficient operation restaurants is opened in the Internet network, a plurality of restaurants 40 are collected as members, and database about the information on the plurality of the member restaurants 40 is created;
a second act wherein a plurality of restaurant customers 20 connect to the website to register as members and register a plurality of the member restaurants 40 as favorite restaurants;
a third act wherein one of the plurality of the restaurant customers 20 orders food on the menu of the restaurant 40 in the website, and a web server 11 of operating the website transfers an order sheet to a facsimile of one of the restaurants 40; and
a fourth act wherein a facsimile machine 42 of the one of the plurality of the restaurants 40 prints the order sheet,
wherein the plurality of the restaurants 40 check the contents of the order sheet and prepare the ordered food so that the restaurant customers 20 pick up the food.

9. The online networking method of claim 8, wherein the second act comprises:
(a) the restaurant customer 20 registering at the website as a member by inputting an identification (ID) and a password, registering a restaurant 40 by inputting the telephone number of the restaurant 40, and submitting the ID, password, and telephone number to a certification server 100;
(b) the certification server 100 interacting with a member database 110 storing the data about the registered members to supply a window in which detailed information on the restaurant customer can be input, and a restaurant server 200 interacting with a restaurant/menu database 210 storing the name, address, telephone numbers of restaurants to display the information on the restaurant 40 having the same telephone number as that input by the restaurant customer 20 on a separate window in the same screen;
(c) the certification server 100 certifying the restaurant customer 20 as a member and registering the restaurant 40 as a favorite restaurant of the restaurant customer 20 by the restaurant customer 20 inputting the detailed information and confirming the restaurant 40; and
(d) an addition banner for favorite restaurants or a banner including a restaurant list displayed on the screen when the restaurant customer 20 who has registered the favorite restaurants signs in the website so that the restaurant customer 20 additionally registers the favorite restaurants by clicking the addition banner and inputting the telephone number of a restaurant 40 or clicking the banner including the restaurant list.

10. The online networking method of claim 8, wherein the second act comprises:
(a) the restaurant customer 20 registering at the website as a member by inputting an ID and a password, registering a restaurant 40 by inputting the telephone number of the restaurant 40, and submitting the ID, password, and telephone number to a certification server 100;
(b) the certification server 100 interacting with a member database 110 storing the data about the registered members in order to supply a window in which detailed information on the restaurant customer can be input, and a restaurant server 200 displaying the list of a plurality of restaurants 40 having the same local number as that of the telephone number input by the restaurant customer 20 in a separate window when the restaurant server 200 cannot find the restaurant 40 having the same telephone number as that input by the restaurant customer 20 from a restaurant/menu database 210 storing the name, address, telephone number, and menu of restaurants 40;
(c) the certification server 100 certifying the restaurant customer 20 as a member and registering the restaurant 40 as a favorite restaurant of the restaurant customer 20 by the restaurant customer 20 inputting the detailed information and confirming at least one restaurant 40 from the restaurant list; and
(d) an addition banner for favorite restaurants or a banner including a restaurant list displayed on the screen when the restaurant customer 20 who has registered the favorite restaurants signs in the website so that the restaurant customer 20 additionally registers the favorite restaurants by clicking on the addition banner and inputting the telephone number of a restaurant 40 or clicking the banner including the restaurant list.

11. The online networking method of claim 10, wherein (b) further includes the restaurant server 200 displaying the list of the plurality of the restaurants 40 related to the name of a restaurant 40 or the local number of the telephone number of the restaurant customer 20 as a keyword in a separate window when the restaurant server 200 cannot find the restaurant 40 having the same telephone number as that input by the restaurant customer 20 from a restaurant/menu database 210.

12. The online networking method of claim 8, wherein the third act further includes:
(1) the restaurant customer 20 signing in the website;
(2) the restaurant customer 20 directly connected to the menu list screen of a previously registered favorite restaurant 40;
(3) the restaurant customer 20 choosing a dish from the menu of the restaurant 40 so that the order history and options of the restaurant customer 20 are displayed, and creating an order sheet by inputting changes in options when needing changes in the options of the food or confirming the order in the other case;
(4) the web server 11 receiving the order sheet; and
(5) the web server 11 converting the order sheet into a facsimile document format to be transferred to a facsimile machine 42 of the restaurant 40.

13. The online networking method of claim 8, wherein the third act further includes:
(1) the restaurant customer 20 signing in the website;
(2) the menus of at least two of the plurality of favorite restaurants 40 previously registered by the restaurant customer 20 on one screen;
(3) the restaurant customer 20 choosing a dish from the menu of the restaurant 40 so that the order history and options of the restaurant customer 20 are displayed, and creating an order sheet by inputting changes in options when needing changes in the options of the food or confirming the order in the other case;
(4) the web server 11 receiving the order sheet; and
(5) the web server 11 converting the order sheet into a facsimile document format in order to transfer it to a facsimile machine 42 of the restaurant 40.

14. An online networking method for an efficient operation of restaurants, the online networking method comprising:
a first act where a service provider 10 opens a website of an online networking service for an efficient operation of restaurants on the Internet, collecting restaurants 40 as members, and creating database about the information on the member restaurants 40 and the food material items required in the member restaurants 40;
a second act where food material providers 30 connect to the website to register as a member and register member restaurants 40 as food material delivery restaurants;
a third act where the food material providers 30 present estimations of food material prices required in the restaurants 40 so that the web server 11 for operating the website transfers the estimations to the facsimile machine 42 of the restaurants 40; and
a fourth act where the facsimile machine 42 of the restaurants 40 prints the estimations,
wherein the food material providers 30 present the estimations of the food material prices required in the restaurants 40 on the website so that the restaurants 40 check the estimations printed by the facsimile machine 42 and order the delivery of food materials from the food material providers 30.

15. The online networking method of claim 14, wherein the second act further includes:
(a) the food material provider 30 registering to the website as a member by inputting an ID and a password, registering a restaurant 40 by inputting the telephone number of the restaurant 40, and submitting the ID, password, and telephone number to a certification server 100;
(b) the certification server 100 interacting with a member database 110 storing the data about the registered members to supply a window in which detailed information on the food material provider can be input, and a food material server 400 interacting with a food material database 410 storing the food materials sorted by restaurants, telephone numbers, estimation contents, and items to display the information on the restaurant 40 having the same telephone number as that input by the food material provider 30 on a separate window in the same screen;
(c) the certification server 100 certifying the food material provider 30 as a member and registering the restaurant 40 as a food material delivery restaurant of the food material provider 30 by the food material provider 30 inputting the detailed information and confirming the restaurant 40;
(d) displaying estimation input windows for each item of food materials required in the restaurants 40 so that the food material provider 30 inputs the prices of the food material in an estimation input window and submits the prices to the web server 11; and
(e) an addition banner for food material delivery restaurants or a banner including a restaurant list displayed on the screen when the food material provider 30 who has registered the food material delivery restaurants signs in the website so that the food material provider 30 additionally registers the food material delivery restaurants by clicking the addition banner and inputting the telephone number of a restaurant 40 or clicking the banner including the restaurant list.

16. The online networking method of claim 14, wherein the second act further includes:
(a) the food material provider 30 registering to the website as a member by inputting an ID and a password, registering a restaurant 40 by inputting the telephone number of the restaurant 40, and submitting the ID, password, and telephone number to a certification server 100;
(b) the certification server 100 interacting with a member database 110 storing the data about the registered members to supply a window in which detailed information on the food material provider can be input, and a food material server 400 displaying the list of restaurants having the same local number as that of the telephone number input by the food material provider 30 in a separate window when the food material server 400 cannot find the restaurant 40 having the same telephone number as that input by the food material provider 30 from a food material database 410 storing the food materials sorted by restaurants, telephone numbers, estimation contents, and items;
(c) the certification server 100 certifying the food material provider 30 as a member and registering the restaurant 40 as a food material delivery restaurant of the food material provider 30 by the food material provider 30 inputting the detailed information and confirming at least one restaurant 40 from the restaurant list;
(d) displaying estimation input windows for each item of food materials required in the restaurants 40 so that the food material provider 30 inputs the prices of the food material in an estimation input window and submits the prices to the web server 11; and
(e) an addition banner for food material delivery restaurants or a banner including a restaurant list displayed on the screen when the food material provider 30 who has registered the food material delivery restaurants signs in the website so that the food material provider 30 additionally registers the food material delivery restaurants by clicking the addition banner and inputting the telephone number of a restaurant 40 or clicking the banner including the restaurant list.

17. The online networking method of claim 10, wherein (b) further includes the food material server 400 displaying the list of restaurants 40 related to the name of a restaurant 40 or the local number of the telephone number of the food material provider 30 as a keyword in a separate window when the food material server 400 cannot find the restaurant 40 having the same telephone number as that input by the food material provider 30 from a food material database 410.

18. The online networking method of claim 14, wherein the third act further includes:
(1) the food material provider 30 signing in the website;
(2) displaying the list of the food material delivery restaurants 40 previously registered by the food material provider 30 on a web page;
(3) the food material provider 30 selecting the restaurants 40 from the list of the food material delivery restaurants 40 to which the food material provider 30 will present an estimation of food material prices;
(4) the food material provider 30 inputting estimated prices for the food material list required in the restaurants 40;
(5) converting the estimated prices presented by a plurality of food material providers into the one-to-one prices by the one-to-one price list to create a final estimation; and
(6) the web server 11 converting the final estimation into a facsimile document format to transfer to a facsimile machine 42 of the restaurant 40.

19. The online networking method of claim 14, wherein the third act further includes:
(1) the food material provider 30 signing in the website;
(2) displaying the list of the food material delivery restaurants 40 previously registered by the food material provider 30 on a web page;
(3) the food material provider 30 selecting the restaurants 40 from the list of the food material delivery restaurants 40 to which the food material provider 30 will present an estimation of food material prices;
(4) the food material provider 30 inputting estimated prices for the food materials when the one-to-one price list is displayed on the screen;
(5) comparing the estimated prices of the food materials presented by a plurality of food material providers to create a final estimation; and
(6) the web server 11 converting the final estimation into a facsimile document format to be transferred to a facsimile machine 42 of the restaurant 40.
